(19) United States
(12) Patent Application Publication
(10) Pub. No.: US 2009/0041288 A1
(43) Pub. Date: Feb. 12, 2009

(54) EAR-LOOP EARPHONE

(76) Inventors: Chun-Hsin Liu, Taipei County (TW); Shu-Yuan Cheng, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/968,656

(22) Filed: Jan. 3, 2008

(30) Foreign Application Priority Data
Aug. 7, 2007 (TW) 096212958

(51) Int. Cl. H04R 1/10

(52) U.S. Cl. 381/381

(57) ABSTRACT

An ear-loop earphone includes a main body having a surrounding side, an ear-loop base, and an ear-loop. The ear-loop base, fixed on the surrounding side of the main body in a rotatable manner, is capable of rotating around a first axis. The ear-loop, fixed on the ear-loop base in a rotatable manner, capable of rotating around a second axis different from the first axis.

### BACKGROUND OF THE INVENTION

1. Field of the Invention

The present invention relates to an ear-loop earphone, and more particularly, to an ear-loop earphone having an ear-loop base fixed on the surrounding side of a main body of the ear-loop earphone in a rotatable manner, and having an ear-loop fixed on the ear-loop base in a rotatable manner.

2. Description of the Prior Art

The earphone, a small audio output device, can be used to not disturb others while receiving an audio signal. With the development of new technology, the time that one wears earphones becomes longer. For example, people use earphones to answer the phone while driving or to listen to music while exercising. Thus, whether wearing the earphone is comfortable or not has become important. In general, ear-loop earphones are often used in daily life because wearing an ear-loop earphone is more comfortable.

However, it cannot be adjusted according to the shape and size of a user's ears because the distance is fixed between the main body and the ear-loop of the stereo ear-loop earphone at present. Besides, there are stereo ear-loop earphones with Bluetooth in the market. This kind of earphone has only one earphone with Bluetooth. These earphones with Bluetooth cannot be worn on the other ear (that is, one designed for the right ear cannot be worn on the left, and vice versa) because the ear-loop cannot be adjusted to fit the other ear, and this causes great inconvenience in use.

### SUMMARY OF THE INVENTION

It is therefore one of the objectives of the present invention to provide an ear-loop earphone in order to solve the above-mentioned problem. According to an exemplary embodiment of the present invention, the ear-loop earphone comprises a main body, an ear-loop base and an ear-loop. The main body has a surrounding side. The ear-loop base is fixed on the surrounding side of the main body in a rotatable manner, and is capable of rotating around a first axis. The ear-loop is fixed on the ear-loop base in a rotatable manner, and is capable of rotating around a second axis different from the first axis.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an ear-loop earphone according to a first exemplary embodiment of the present invention.

FIG. 2 to FIG. 5 are diagrams illustrating how to change the position of the ear-loop relative to the main body of the ear-loop earphone of the present invention.

FIG. 6 is a schematic diagram illustrating the ear-loop earphone according to the first exemplary embodiment of the present invention.

FIG. 7 is a partial perspective cross-sectional diagram illustrating the ear-loop earphone according to the first exemplary embodiment of the present invention.

FIG. 8 is a schematic diagram illustrating an ear-loop earphone according to a second exemplary embodiment of the present invention.

FIG. 9 is a partial perspective cross-sectional diagram illustrating the ear-loop earphone according to the second exemplary embodiment of the present invention.

### DETAILED DESCRIPTION

Those skilled in the art will readily observe that numerous modifications and alterations of the device and method may be made while retaining the teachings of the invention. Accordingly, the above disclosure should be construed as limited only by the metes and bounds of the appended claims.

Different features of the present invention are detailed below in reference to the figures, and for convenience of explanation, the same elements in separate figures are indicated by the same reference numerals. The main body 110 has a surrounding side 112. The ear-loop base 120 is fixed on the surrounding side 112 of the main body 110 in a rotatable manner, and is capable of rotating around a first axis A. The ear-loop 130 is fixed on the ear-loop base 120 in a rotatable manner, and is capable of rotating around a second axis B different from the first axis A. Further description of the operation and implementation of the ear-loop earphone 100 is as follows. This is merely for illustrative purposes, however, and is not meant to be a limitation of the present invention.

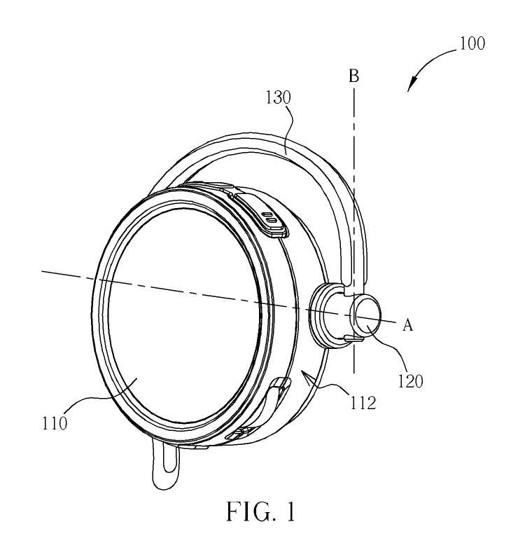

Please refer to FIG. 1. FIG. 1 is a diagram illustrating an ear-loop earphone 100 according to a first exemplary embodiment of the present invention. In this embodiment, the ear-loop earphone 100 comprises a main body 110, an ear-loop base 120 and an ear-loop 130.

Please note that the main body 110 has a round shape in this embodiment. however, this is not a limitation of the present invention. In other words, the main body 110 can have another shape, such as a square or an ellipse. Thus, the shape of the above-mentioned surrounding side is also not the limitation of the present invention. The surrounding side surrounding the side of the main body with any shape also obeys the spirit of the present invention.

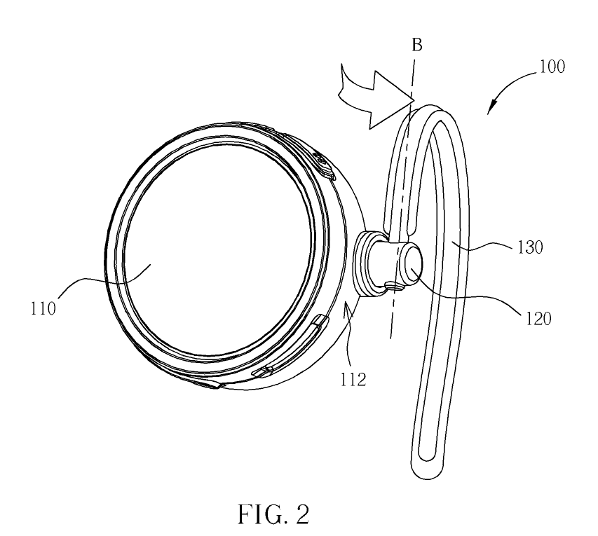

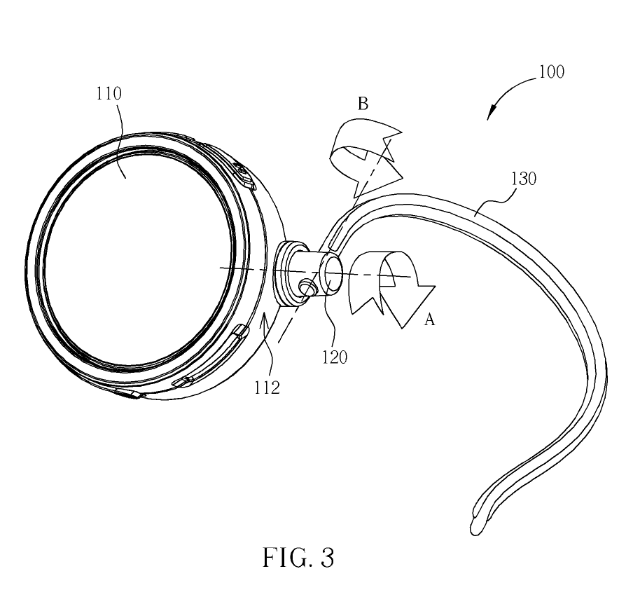

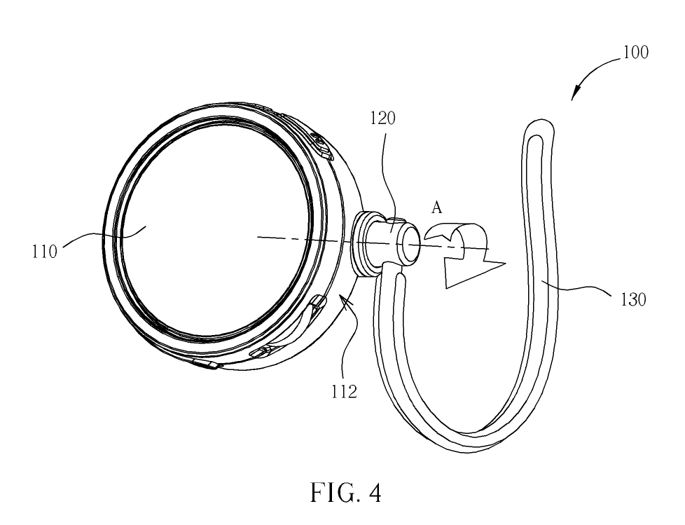

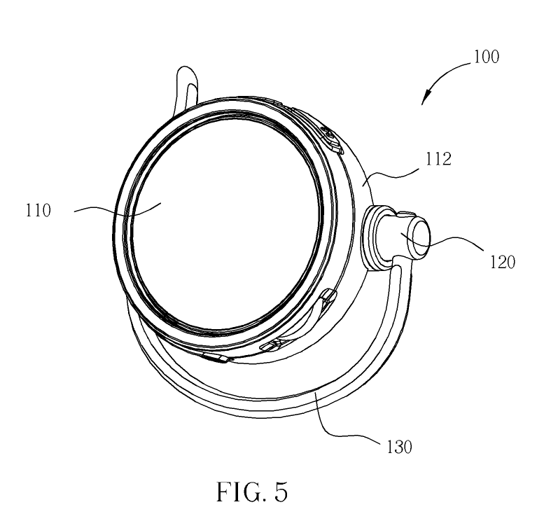

Please refer to FIG. 2 to FIG. 5 and FIG. 1 together. FIG. 2 to FIG. 5 are diagrams illustrating how to change the position of the ear-loop 130 relative to the main body 110 of the ear-loop earphone 100 of the present invention, and the steps are illustrated as follows. The structure of the ear-loop earphone 100 as shown in FIG. 1 is for user's right ear. To change the position of the ear-loop 130 so as to fit the ear-loop earphone 100 to the left ear, firstly, as shown in FIG. 2, the ear-loop 130 is rotated some degrees departing from an original position (e.g., the position for user's right ear) around the second axis B. Next, as shown in FIG. 3 and FIG. 4, the ear-loop base 120 is rotated 180 degrees around the first axis A. In the process of rotating the ear-loop base 120, the ear-loop 130 can also be rotated so as to rotate the ear-loop base 120 more easily. Lastly, as shown in FIG. 5, the ear-loop 130 is rotated to a symmetrical position (e.g., the position for user's left ear) relative to the original position around the second axis B. In this way, the object of changing the position of the ear-loop is achieved. Please note that in this embodiment, rotating the ear-loop base 120 only 180 degrees around the first axis A can achieve the objective of changing the position of the ear-loop. This is not a limitation of the present invention, however, as the ear-loop base 120 can be allowed to be rotated 360 degrees around the first axis A.

Please note that if the objective of changing the position of the ear-loop can be achieved, the operation steps are not limited to the order shown in FIG. 1 to FIG. 5. The order of the operation steps are merely for illustrative purposes only and are not meant to be a limitation of the present invention.

After reading the above-mentioned description concerning how to switch the position of the ear-loop 130 for a user's left ear from for the user's right ear, a method for modifying the ear-loop earphone 100 should be readily appreciated by those skilled in the art, so further description concerning how to switch the position of the ear-loop 130 for the user's right ear from for use on the left ear is omitted here for the sake of brevity.

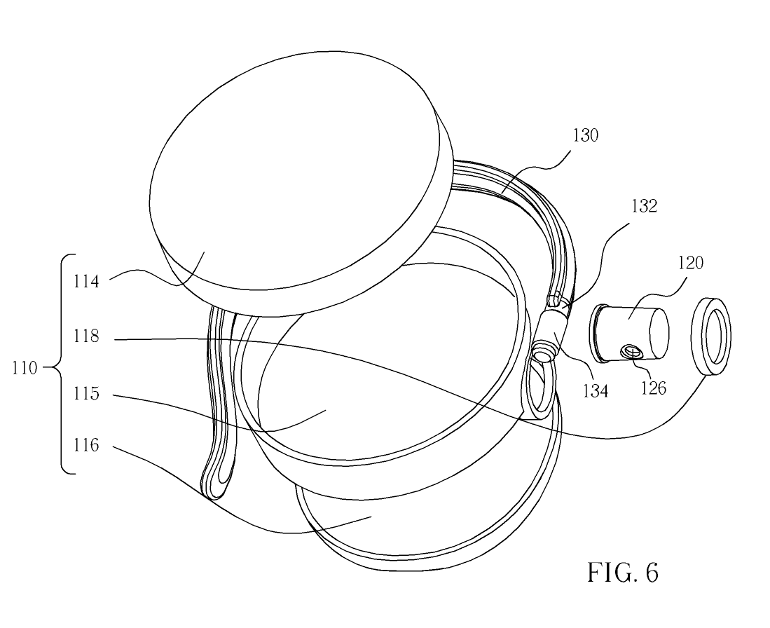

Please refer to FIG. 6. FIG. 6 is a schematic diagram illustrating the ear-loop earphone 100 according to the first exemplary embodiment of the present invention. As shown in FIG. 6, the ear-loop earphone 100 comprises the main body 110, the ear-loop base 120 and the ear-loop 130. The main body 110 has a first housing 114, a second housing 115, a sponge pad 116 and a base cover 118. The base cover 118 is disposed on the second housing 115. In practice, the base cover 118 can be fixed on the second housing 115 by means of locking with each other, using an ultrasonic wave melting process or adhesive. The ear-loop base 120 has a hole 126. The ear-loop 130 has a shaft 132 and the shaft 132 is covered with a flexible element 134. In this embodiment, the flexible element 134 is implemented by a rubber ring; however, this is not a limitation of the present invention. Furthermore, in this embodiment, the main body 110 has the first housing 114 and the second housing 115; however, this is also not a limitation of the present invention. For example, the first housing 114 and second housing 115 can be replaced with a single monolithic housing, and this also obeys the spirit of the present invention.

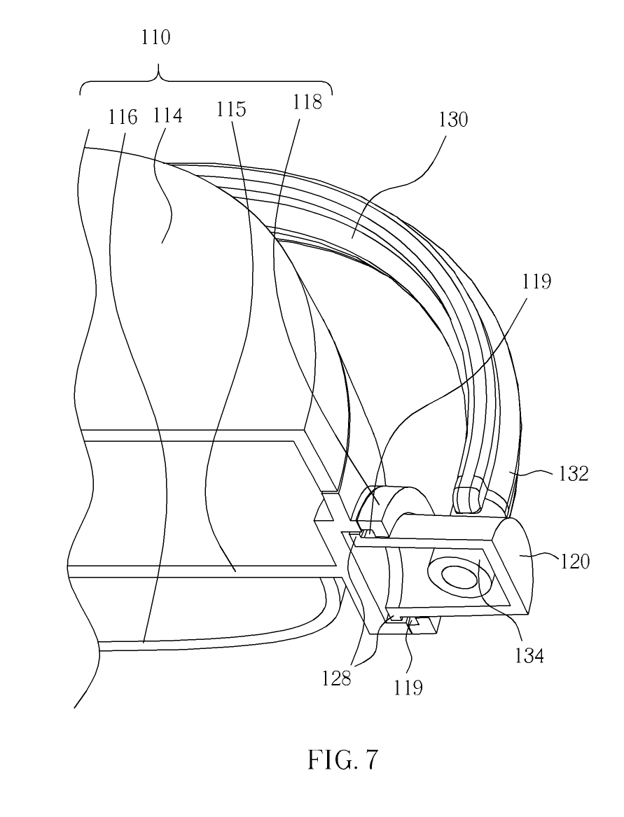

Please refer to FIG. 7. FIG. 7 is a partial perspective cross-sectional diagram illustrating the ear-loop earphone 100 according to the first exemplary embodiment of the present invention. As shown in FIG. 7, the shaft 132 of the ear-loop 130 passes through the hole 126 (not shown in FIG. 7) of the ear-loop base 120 to fix the ear-loop 130 on the ear-loop base 120 in a rotatable manner. The flexible element 134 (i.e., rubber ring) covering the shaft 132 is utilized for providing the ear-loop base 120 with a contact force to install the shaft 132 in the hole 126 of the ear-loop base 120.

Please refer to FIG. 7 again. The main body 110 has a circular track 119, and the circular track 119 is formed by the second housing 115 and the base cover 118. One end of the ear-loop base 120 has a circular protrusion 128 corresponding to the circular track 119, and the circular protrusion 128 is installed in the circular track 119 to fix the ear-loop base 120 in the main body 110 in a rotatable manner.

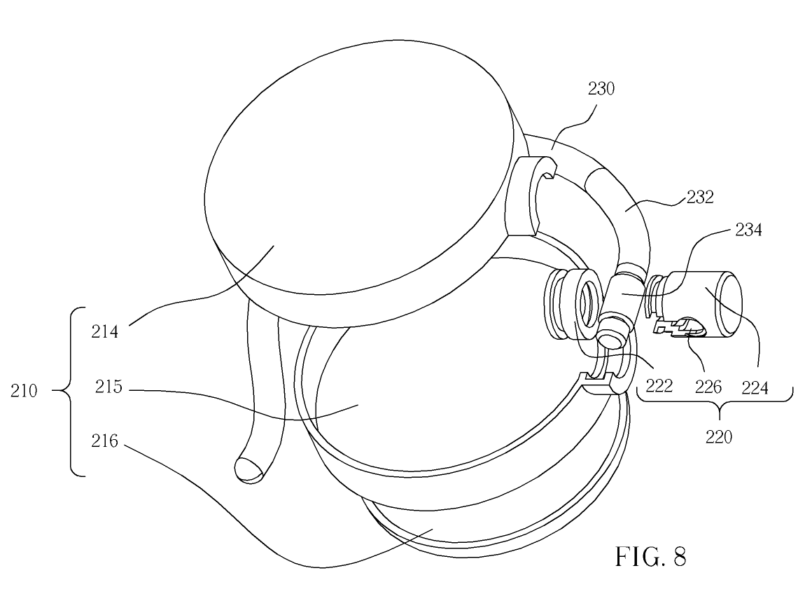

Please note that the structure of the ear-loop earphone 100 mentioned in the above embodiment is for illustrative purposes only, and it is not a limitation of the present invention. That is to say, in other embodiments, the ear-loop earphone can have a different structure depending on design requirements. Please refer to FIG. 8. FIG. 8 is a schematic diagram illustrating an ear-loop earphone 200 according to a second exemplary embodiment of the present invention. As shown in FIG. 8, a main body 210 of the ear-loop earphone 200 has a first housing 214, a second housing 215 and a sponge pad 216. An ear-loop base 220 has a first pivot element 222 and a second pivot element 224, and the second pivot element 224 has a hole 226. An ear-loop 230 has a shaft 232 and the shaft 232 is covered with a flexible element 234. In this embodiment, the flexible element 234 is implemented by a rubber ring.

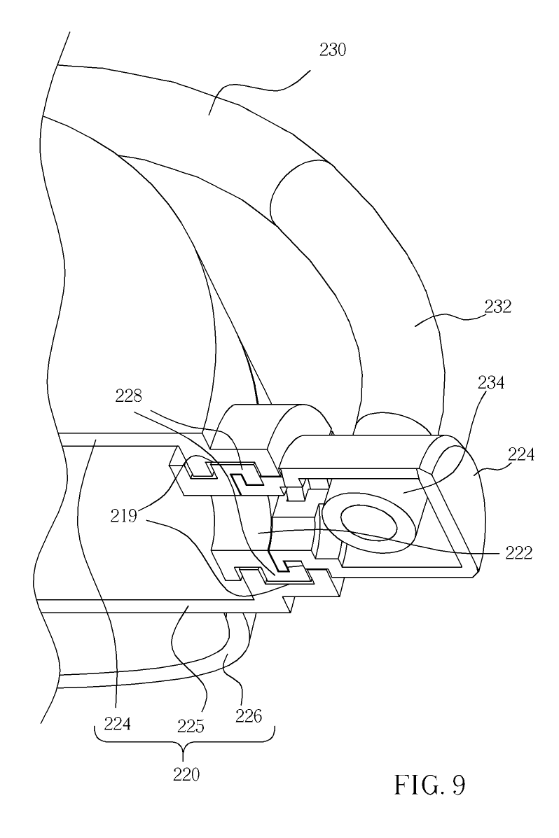

Please refer to FIG. 9. FIG. 9 is a partial perspective cross-sectional diagram illustrating the ear-loop earphone 200 according to the second exemplary embodiment of the present invention. As shown in FIG. 9, the ear-loop base 220 is formed by the first pivot element 222 and the second pivot element 224. The shaft 232 passes through the hole 226 (not shown in FIG. 9) of the second pivot element 224 in order to fix the ear-loop 230 on the ear-loop base 220 in a rotatable manner. The flexible element 234 (i.e., rubber ring) covering the shaft 232 is utilized for providing the ear-loop base 220 with a contact force to install the shaft 232 in the hole 226 of the second pivot element 224. Please note that the material of the flexible element 234 is rubber, but this is not a limitation of the present invention.

Please refer to FIG. 9 again. The main body 210 has a circular track 219, and the circular track 219 is formed by the first housing 214 and the second housing 215. One end of the ear-loop base 220 has a circular protrusion 228 corresponding to the circular track 219, and the circular protrusion 228 is disposed on the first pivot element 222. The circular protrusion 228 is installed in the circular track 219 to fix the ear-loop base 220 in the main body 210 in a rotatable manner.

Since the method for using the ear-loop earphone 200 is similar to that for using the ear-loop earphone 100, after reading the above-mentioned description concerning how to switch the position of the ear-loop 130 of the ear-loop earphone 100, a corresponding method for switching the position of the ear-loop 230 of the ear-loop earphone 200 should be readily appreciated by those skilled in the art, so further description concerning the method for using the ear-loop earphone 200 is omitted here.

Please note that a stereo earphone apparatus can comprise the ear-loop earphone of the present invention. For example, the stereo earphone apparatus is a Bluetooth stereo earphone apparatus: one side of the earphone with Bluetooth can be used as a hands-free receiver, and another side of the earphone without Bluetooth. The side of the earphone with Bluetooth is the ear-loop earphone of the present invention. The position of the ear-loop of the side of the earphone with Bluetooth can be adjusted depending on the user's preference in order to fit the user's right or left ear when being used as a hands-free receiver.

If the side of the earphone without Bluetooth is for use on the left (or right) ear, the ear-loop of the other side of the earphone (the side with Bluetooth) can be adjusted to a normal position for the right (or left) ear to allow the stereo earphone apparatus to be used as stereo earphones. However, this is not a limitation of the present invention. For example, two sides of the earphones are both the ear-loop earphones of the present invention, and this also obeys the spirit of the present invention.

Compared to the prior art, the ear-loop earphone of the present invention can be fitted for the left or right ear by means of easily rotating the ear-loop. Furthermore, the distance can be adjusted according to the shape and size of user's ear between the earphone and the ear-loop in order to increase the comfort while wearing the earphone.

Those skilled in the art will readily observe that numerous modifications and alterations of the device and method may be made while retaining the teachings of the invention.

What is claimed is:

1. An ear-loop earphone, comprising:
a main body, having a surrounding side;
an ear-loop base, fixed on the surrounding side of the main body in a rotatable manner, wherein the ear-loop base is allowed to rotate around a first axis; and
an ear-loop, fixed on the ear-loop base in a rotatable manner, wherein the ear-loop is allowed to rotate around a second axis different from the first axis.

2. The ear-loop earphone of claim 1, wherein the ear-loop base has a hole and the ear-loop has a shaft, and the shaft passes through the hole to fix the ear-loop in the ear-loop base in a rotatable manner.

3. The ear-loop earphone of claim 2, wherein the shaft is covered with a flexible element, which is utilized for exerting a contact force upon the ear-loop base to install the shaft in the hole of the ear-loop base.

4. The ear-loop earphone of claim 1, wherein the main body has a circular track and one end of the ear-loop base has a circular protrusion corresponding to the circular track, and the circular protrusion is installed in the circular track to fix the ear-loop base in the main body in a rotatable manner.

5. The ear-loop earphone of claim 4, wherein the main body has a first housing and a second housing, and the circular track is formed by the first housing and the second housing.

6. The ear-loop earphone of claim 4, wherein the main body has a housing and a base cover which is disposed on the housing, and the circular track is formed by the housing and the base cover.

7. The ear-loop earphone of claim 4, wherein the main body comprises:
a first pivot element, having the circular protrusion and a fixing circular track; and
a second pivot element, having a fixing circular protrusion;
wherein the fixing circular protrusion is installed in the fixing circular track to fix the first pivot element in the second pivot element.

8. The ear-loop earphone of claim 7, wherein the second pivot element has a hole and the ear-loop has a shaft, and the shaft is through the hole to fix the ear-loop in the ear-loop base in a rotatable manner.

9. A stereo earphone apparatus, comprising the ear-loop earphone of claim 1.
